(19) United States
(12) Patent Application Publication
(10) Pub. No.: US 2025/0077452 A1
(43) Pub. Date: Mar. 6, 2025

(54) INTERRUPT-PROHIBITED SECTION MEASUREMENT METHOD AND SYSTEM

(71) Applicant: HYUNDAI AUTOEVER CORP., Seoul (KR)

(72) Inventor: Ji Hoon JUNG, Seoul (KR)

(21) Appl. No.: 18/819,160

(22) Filed: Aug. 29, 2024

(30) Foreign Application Priority Data
Aug. 31, 2023 (KR) 10-2023-0115756

(51) Int. Cl. G06F 13/24; G06F 9/32

(52) U.S. Cl. CPC G06F 13/24; G06F 9/321

(57) ABSTRACT

An interrupt-prohibited section measurement method is performed by a computing system. The interrupt-prohibited section measurement method comprises increasing an interrupt count in response to a first interrupt request signal, recording a first time, which is the time when the first interrupt request signal is sent, based on the increase in the interrupt count, decreasing the interrupt count in response to a second interrupt request signal different from the first interrupt request signal, recording a second time, which is the time when the second interrupt request signal is sent, based on the decrease in the interrupt count, and calculating a duration of the interrupt-prohibited section using the first and second times.

### CROSS-REFERENCE TO RELATED APPLICATION

This application claims priority from Korean Patent Application No. 10-2023-0115756 filed on Aug. 31, 2023, in the Korean Intellectual Property Office, and all the benefits accruing therefrom under 35 U.S.C. 119, the contents of which in its entirety are herein incorporated by reference.

### BACKGROUND

### 1. Field

The present disclosure relates to an interrupt-prohibited section measurement method and system, and more specifically, to a method for measuring an interrupt-prohibited section through selective processing of interrupt request signals, and a system performing the method.

### 2. Description of the Related Art

An interrupt can be classified into either a hardware interrupt or a software interrupt. First, a hardware interrupt occurs when an exceptional situation arises in devices such as input/output (I/O) hardware during the execution of a program (or a task) by the central processing unit (CPU). This requires the CPU to be notified to handle the exceptional situation with priority. On the other hand, a software interrupt occurs when an exceptional situation arises due to changes in commands executed within the CPU or related modules during the execution of a program (or a task) by the CPU. This also requires the CPU to be notified to handle the exceptional situation with priority.

AUTomotive Open System ARchitecture (AUTOSAR) is a standardized automotive platform designed to cope with the increasing use of embedded systems in vehicle electronic components. The Timing Protection mechanism of the AUTOSAR Operating System (OS) can handle errors for timing faults that occur when tasks fail to meet their deadline. However, the AUTOSAR OS does not provide monitoring for deadlines required for Timing Protection.

To address this, a method capable of measuring an interrupt-prohibited section that can serve the purpose of deadline monitoring for Timing Protection is needed.

### SUMMARY

Aspects of the present disclosure provide a method for accurately measuring the duration of an interrupt-prohibited section and a system performing the method.

Aspects of the present disclosure also provide a method for measuring the duration of an interrupt-prohibited section by selectively adopting interrupt signals and a system performing the method.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided an interrupt-prohibited section measurement method, performed by a computing system. The interrupt-prohibited section measurement method comprises increasing an interrupt count in response to a first interrupt request signal, recording a first time, which is the time when the first interrupt request signal is sent, based on the increase in the interrupt count, decreasing the interrupt count in response to a second interrupt request signal different from the first interrupt request signal, recording a second time, which is the time when the second interrupt request signal is sent, based on the decrease in the interrupt count, and calculating a duration of the interrupt-prohibited section using the first and second times.

In some embodiments, the first interrupt request signal may include multiple request signals, and each of the multiple first interrupt request signals may precede the second interrupt request signal.

In some embodiments, the first time may be the time when the earliest of the multiple first interrupt request signals is recorded.

In some embodiments, the second interrupt request signal may include multiple request signals, and the second time may be the time when the latest of the multiple second interrupt request signals is recorded.

In some embodiments, the recording the first time, may comprise recording the first time when the first interrupt request signal is sent, based on the increase in the interrupt count, if the interrupt count becomes 1.

In some embodiments, the recording the second time, may comprise recording the second time when the second interrupt request signal is sent, based on the decrease in the interrupt count, if the interrupt count becomes 0.

In some embodiments, the calculating the duration of the interrupt-prohibited section, may comprise calculating the duration of the interrupt-prohibited section by subtracting the first time from the second time.

In some embodiments, the method further may comprise: if the calculated duration of the interrupt-prohibited section exceeds a predetermined maximum value, updating the predetermined maximum value and recording the duration calculated by subtracting the first time from the second time in a program counter.

In some embodiments, the method may further comprise: if the calculated duration of the interrupt-prohibited section is equal to or less than the predetermined maximum value, increasing the interrupt count in response to another first interrupt request signal, recording a first time, which is the time when the other first interrupt request signal is sent, based on the increase in the interrupt count, decreasing the interrupt count in response to another second interrupt request signal different from the other first interrupt request signal, and recording a second time, which is the time when the other second interrupt request signal is sent, based on the decrease in the interrupt count.

According to an aspect of the present disclosure, there is provided an interrupt-prohibited section measurement system comprising at least one processor, and a memory storing instructions, wherein by executing the stored instructions, the at least one processor performs the operations of: increasing an interrupt count in response to a first interrupt request signal; recording a first time, which is the time when the first interrupt request signal is sent, based on the increase in the interrupt count; decreasing the interrupt count in response to a second interrupt request signal different from the first interrupt request signal; recording a second time, which is the time when the second interrupt request signal is sent, based on the decrease in the interrupt count; and calculating a duration of the interrupt-prohibited section using the first and second times.

In some embodiments, the first interrupt request signal may include multiple request signals, and each of the multiple first interrupt request signals may precede the second interrupt request signal.

In some embodiments, the first time may be the time when the earliest of the multiple first interrupt request signals is recorded.

In some embodiments, the second interrupt request signal may include multiple request signals, and the second time may be the time when the latest of the multiple second interrupt request signals is recorded.

In some embodiments, the operation of recording the first time, may comprise recording the first time when the first interrupt request signal is sent, based on the increase in the interrupt count, if the interrupt count becomes 1.

In some embodiments, the operation of recording the second time, may comprise recording the second time when the second interrupt request signal is sent, based on the decrease in the interrupt count, if the interrupt count becomes 0.

In some embodiments, the operation of calculating the duration of the interrupt-prohibited section, may comprise calculating the duration of the interrupt-prohibited section by subtracting the first time from the second time.

In some embodiments, the at least one processor may further perform the operation of: if the calculated duration of the interrupt-prohibited section exceeds a predetermined maximum value, updating the predetermined maximum value and recording the duration calculated by subtracting the first time from the second time in a program counter.

In some embodiments, the at least one processor may further perform the operation of: if the calculated duration of the interrupt-prohibited section is equal to or less than the predetermined maximum value, increasing the interrupt count in response to another first interrupt request signal; recording a first time, which is the time when the other first interrupt request signal is sent, based on the increase in the interrupt count; reducing the interrupt count in response to another second interrupt request signal different from the other first interrupt request signal; and recording a second time, which is the time when the other second interrupt request signal is sent, based on the reduction in the interrupt count.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a flowchart illustrating an interrupt-prohibited section measurement method according to an embodiment of the present disclosure;

FIG. 2 is a diagram illustrating an exemplary interrupt-prohibited section;

FIG. 3 is a detailed flowchart illustrating step S12 of FIG. 1, showing how the interrupt processing server records the first time;

FIG. 4 is a detailed flowchart illustrating step S14 of FIG. 1, showing how the interrupt processing server records the second time;

FIG. 5 is a detailed flowchart illustrating step S15 of FIG. 4 where the interrupt processing server calculates the interrupt-prohibited section; and

FIG. 6 is an exemplary hardware configuration view of an interrupt-prohibited section measurement system according to some embodiments of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

First, some terms mentioned in this disclosure will hereinafter be explained.

### [Interrupt]

An interrupt can be classified into either a hardware interrupt or a software interrupt. A hardware interrupt occurs when an exceptional situation arises in devices such as input/output (I/O) hardware during the execution of a program (or task) by the central processing unit (CPU), necessitating the CPU to be notified to prioritize handling the exceptional situation.

Examples of the hardware interrupt include an I/O interrupt, a power fail interrupt, a machine check interrupt, and an external interrupt.

A software interrupt occurs when an exceptional situation arises due to changes in commands executed within the CPU or related modules during the execution of a program (or task) by the CPU, necessitating the CPU to be notified to prioritize handling the exceptional situation. Examples of the software interrupt include those caused by program errors.

In some embodiments of the present disclosure, the term “interrupt” may refer to both hardware and software interrupts. Therefore, embodiments of the present disclosure for measuring the duration of an interrupt-prohibited section aim to measure the period during which interrupts do not occur in situations where hardware and software interrupts are expected to occur.

### [AUTOSAR Timing Protection]

AUTomotive Open System ARchitecture (AUTOSAR) is a standardized automotive platform designed to cope with the increasing use of embedded systems in vehicle electronic components. Embodiments of the present disclosure can provide a method and system for the AUTOSAR Operating System (OS) to measure interrupt-prohibited sections.

Timing Protection can handle errors for timing faults that occur when tasks fail to meet their deadline. However, the AUTOSAR OS does not provide monitoring for deadlines required for Timing Protection.

To address this, an interrupt-prohibited section measurement method according to some embodiments that can serve the purpose of deadline monitoring for Timing Protection is provided, and detailed explanations thereof will be provided below.

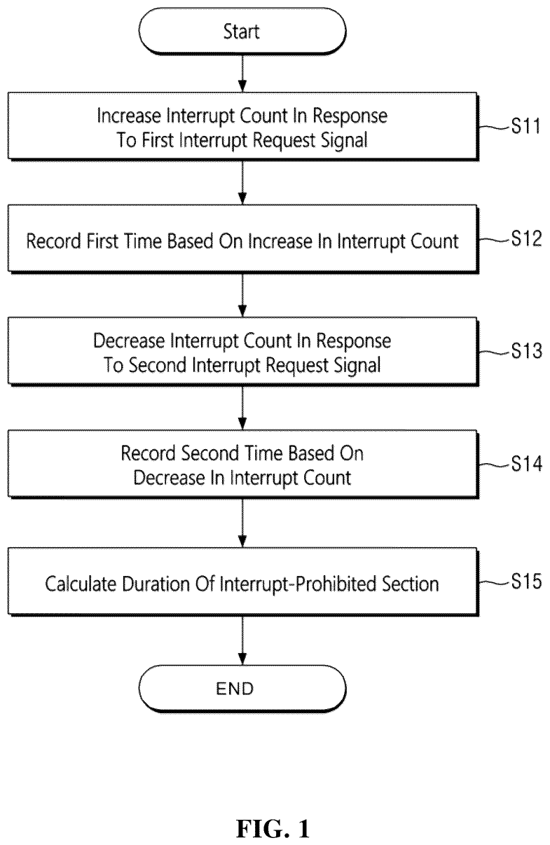

FIG. 1 is a flowchart illustrating an interrupt-prohibited section measurement method according to an embodiment of the present disclosure.

Referring to FIG. 1, in step S11, an interrupt processing server may be increased an interrupt count in response to one or more first interrupt request signals. Here, the term “first interrupt” may refer to a suspend interrupt, and the term “first interrupt request” may refer to an interrupt request indicating the start of an interrupt-prohibited section.

Additionally, in step S11, the interrupt count may be increased in proportion to the number of first interrupt request signals received. For example, if one first interrupt request signal is received, the interrupt count may be increased by one, and if two first interrupt request signals are received, the interrupt count may be increased by two. Therefore, by calculating the interrupt count inversely, the number of first interrupt request signals sent may be determined.

In step S12, an interrupt processing server may record a first time based on the increase in the interrupt count. Here, the first time may refer to the time when the first interrupt request signals were sent.

If multiple first interrupt request signals are sent, which of the first interrupt request signals is to be recorded as the first time may be set by the administrator of the interrupt processing server or by a user.

In step S13, the interrupt processing server may decrease the interrupt count in response to one or more second interrupt request signals. Here, the term “second interrupt” may refer to a resume interrupt, and the term “second interrupt request” may refer to an interrupt request indicating the end of the interrupt-prohibited section.

In step S13, the interrupt count may be decreased in proportion to the number of second interrupt request signals received. For example, if one second interrupt request signal is received, the interrupt count may be decreased by one, and if two second interrupt request signal are received, the interrupt count may be decreased by two. Therefore, by calculating the interrupt count inversely, the number of second interrupt request signals sent may be determined.

In step S14, the interrupt processing server may record a second time based on the decrease in the interrupt count. Here, the second time may refer to the time when the second interrupt request signals were sent.

If multiple second interrupt request signals are sent, which of the multiple second interrupt request signals is to be recorded as the second time may be set by the administrator of the interrupt processing server or by the user.

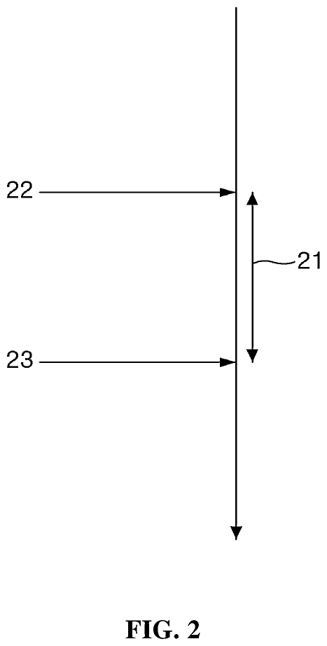

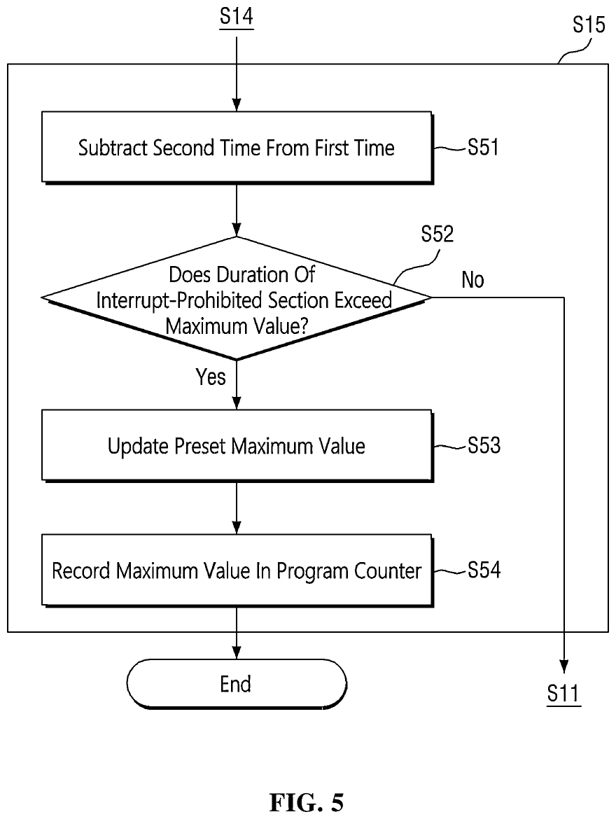

In step S15, the interrupt processing server may calculate the duration of the interrupt-prohibited section. Here, the duration of the interrupt-prohibited section may be calculated using the first and second times, which will be described later in further detail with reference to FIG. 5. FIG. 2 is a diagram illustrating an exemplary interrupt-prohibited section.

Referring to FIG. 2, a first interrupt request signal 22 may precede a second interrupt request signal 23, and an interrupt-prohibited section 21 may exist between a first time when the first interrupt request signal 22 is sent, and a second time when the second interrupt request signal 23 is sent. Specifically, the interrupt-prohibited section 21 may be formed between a first time when the first interrupt is recorded, and a second time when the second interrupt is recorded.

Additionally, there may be multiple first interrupt request signals 22. If there are multiple first interrupt request signals 22, each of the multiple first interrupt request signals 22 may precede the second interrupt request signal 23. The first time, which marks the beginning of an interrupt-prohibited section, may be the time when the earliest of the multiple first interrupt request signals 23 is recorded.

Similarly, there may be multiple second interrupt request signals. If there are multiple second interrupt request signals 23, each of the multiple second interrupt request signals 23 may be sent following the first interrupt request signal(s) 22. The second time, which marks the end of the interrupt-prohibited section, may be the time when the latest of the multiple second interrupt request signals 23 is recorded.

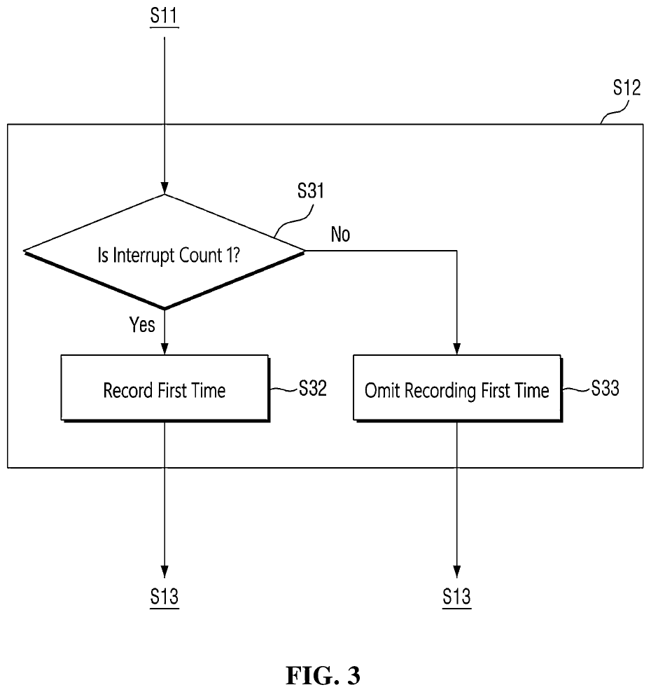

FIG. 3 is a detailed flowchart illustrating step S12 of FIG. 1, showing how the interrupt processing server records the first time.

Referring to FIG. 3, if in step S11, the interrupt count is increased in response to a first interrupt request signal, then in step S31, the interrupt processing server may determine whether the interrupt count is 1. Here, the interrupt count of 1 is merely exemplary, and the interrupt count may also be set to other values.

In step S32, if the interrupt count is 1, the interrupt processing server may record the first time. That is, if the interrupt count is 1, the interrupt processing server may record the first time when the first interrupt request signal was sent, based on the increase in the interrupt count.

Thereafter, the interrupt-prohibited section measurement method may proceed to step S13 where the interrupt count is decreased in response to a second interrupt request signal. If there are multiple first interrupt request signals, the interrupt processing server may continuously perform the steps illustrated in FIG. 3.

For example, if there are multiple first interrupt request signals, the interrupt count may have a value other than 1 that exceeds 1. Thus, if in step S31, the interrupt count is determined not to be 1, then in step S33, the interrupt processing server may omit recording the first time.

As the recording of the first time is omitted in step S33, the mechanism for increasing the interrupt count based on the first interrupt request signal(s) may be terminated. After the mechanism for increasing the interrupt count is terminated, the interrupt processing server may decrease the interrupt count in response to a second interrupt request signal in step S13.

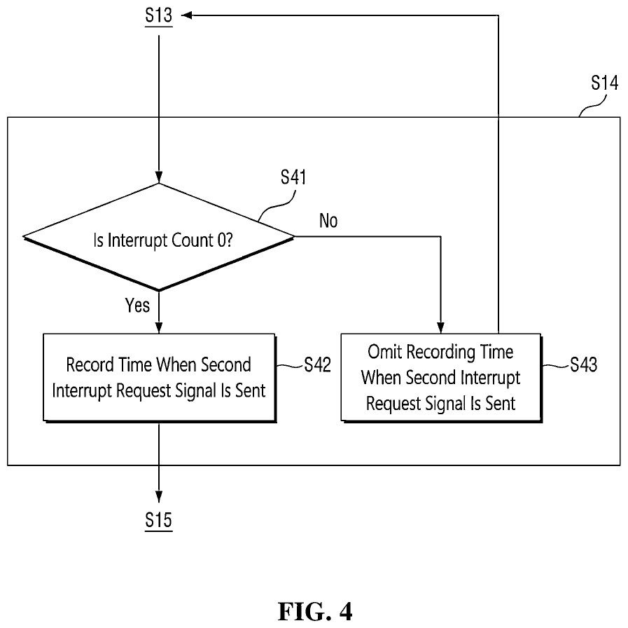

FIG. 4 is a detailed flowchart illustrating step S14 of FIG. 1, showing how the interrupt processing server records the second time.

Referring to FIG. 4, if in step S13, the interrupt count is decreased in response to a second interrupt request signal, then in step S41, the interrupt processing server may determine whether the interrupt count is 0. Here, the interrupt count of 0 is merely exemplary, and the interrupt count may also be set to other values.

In step S42, if the interrupt count is 0, the interrupt processing server may record the second time. That is, if the interrupt count is 0, the interrupt processing server may record the second time when the second interrupt request signal was sent, based on the decrease in the interrupt count.

After the second time is recorded, the interrupt-prohibited section measurement method may proceed to step S15 where the duration of the interrupt-prohibited section is calculated using the first and second times. If there are multiple second interrupt request signals, the interrupt processing server may continuously perform the steps illustrated in FIG. 4.

For example, if there are multiple second interrupt request signals, the interrupt count may have a value other than 0 that exceeds 0. Thus, if in step S41, the interrupt count is determined not to be 0, then in step S43, the interrupt processing server may omit recording the second time.

After omitting the recording of the second time in step S43, the interrupt-prohibited section measurement method may return to step S13 where the interrupt processing server decreases the interrupt count in response to a second interrupt request signal.

FIG. 5 is a detailed flowchart illustrating step S15 of FIG. 4 where the interrupt processing server calculates the interrupt-prohibited section.

Referring to FIG. 5, in step S51, the interrupt processing server may calculate the duration of the interrupt-prohibited section using the first time recorded in step S12 and the second time recorded in step S14. Specifically, the interrupt processing server may calculate the duration of the interrupt-prohibited section by subtracting the first time from the second time.

In step S52, the interrupt processing server may determine whether the duration of the interrupt-prohibited section exceeds a predetermined maximum value. The predetermined maximum value may be set by the administrator of the interrupt processing server or by the user.

If the duration of the interrupt-prohibited section calculated in step S51 exceeds the predetermined maximum value, then in step S53, the predetermined maximum value may be updated, and in step S54, the updated maximum may be recorded in a program counter.

However, if the duration of the interrupt-prohibited section calculated in step S51 does not exceed the predetermined maximum value, the interrupt-prohibited section measurement method may return to step S11 of FIG. 1 where the interrupt count is increased in response to a first interrupt request signal.

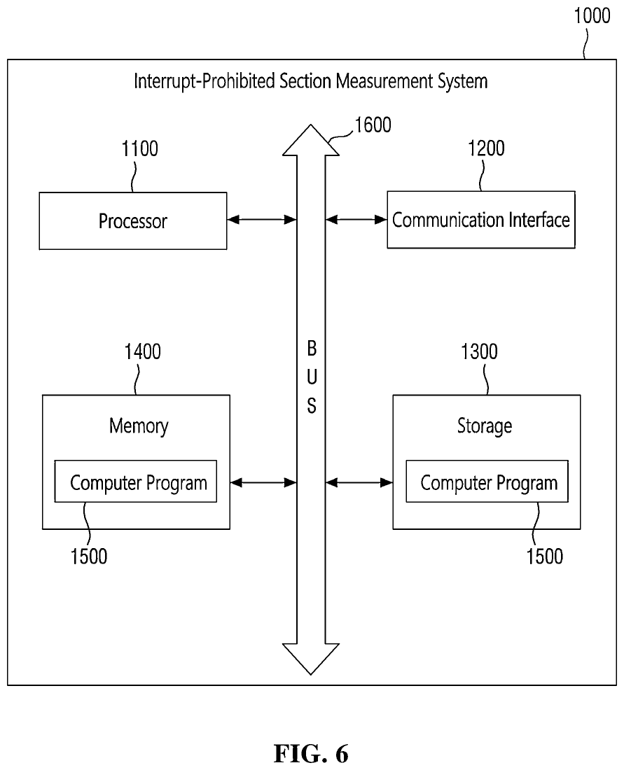

The interrupt-prohibited section measurement according to some embodiments of the present disclosure has been described so far with reference to FIGS. 1 through 5. The hardware configuration of an interrupt-prohibited section measurement system according to some embodiments of the present disclosure will hereinafter be described with reference to FIG. 6.

FIG. 6 is a hardware configuration diagram of an exemplary interrupt-prohibited section measurement system 1000.

Referring to FIG. 6, the interrupt-prohibited section measurement system 1000 may include one or more processors 1100, a bus 1600, a communication interface 1200, a memory 1400, which loads a computer program 1500 executed by the processors 1100, and a storage 1300 for storing the computer program 1500.

Referring to FIG. 6, an interrupt-prohibited section measurement system 1000 is a system that can detect and measure whether an interrupt occurs, and may be used to meet safety and security requirements. For example, the interrupt-prohibited section measurement system 1000 may be used to prevent a robot working in a factory from entering a particular area or to ensure that a particular experimental process in a laboratory is not interrupted, but the present disclosure is not limited thereto.

The processor 1100 controls overall operations of each component of the interrupt-prohibited section measurement system 1000. The processor 1100 may be configured to include at least one of a Central Processing Unit (CPU), a Micro Processor Unit (MPU), a Micro Controller Unit (MCU), a Graphics Processing Unit (GPU), Neural Processing Unit (NPU), or any type of processor well known in the art. Further, the processor 1100 may perform calculations on at least one application or program for executing a method/operation according to various embodiments of the present disclosure. The interrupt-prohibited section measurement system 1000 may have one or more processors.

The memory 1400 stores various data, instructions and/or information. The memory 103 may load one or more programs 1500 from the storage 1300 to execute methods/operations according to various embodiments of the present disclosure. An example of the memory 1400 may be a RAM, but is not limited thereto.

The bus 1600 provides communication between components of the interrupt-prohibited section measurement system 1000. The bus 1600 may be implemented as various types of bus such as an address bus, a data bus and a control bus.

The communication interface 1200 supports wired and wireless internet communication of the interrupt-prohibited section measurement system 1000. The communication interface 1200 may support various communication methods other than internet communication. To this end, the communication interface 1200 may be configured to comprise a communication module well known in the art of the present disclosure.

The storage 1300 can non-temporarily store one or more computer programs 1500. The storage 1300 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 1500 may include one or more instructions, on which the methods/operations according to various embodiments of the present disclosure are implemented. When the computer program 1500 is loaded on the memory 1400, the processor 1100 may perform the methods/operations in accordance with various embodiments of the present disclosure by executing the one or more instructions.

For example, a computer program 1500 may include instructions for performing the operations of: increasing an interrupt count in response to a first interrupt request signal; recording a first time, which is the time when the first interrupt request signal is sent, based on the increase in the interrupt count; decreasing the interrupt count in response to a second interrupt request signal different from the first interrupt request signal; recording a second time, which is the time when the second interrupt request signal is sent, based on the decrease in the interrupt count; and calculating the duration of an interrupt-prohibited section using the first and second times.

The hardware configuration of the interrupt-prohibited section measurement system 1000 has been described so far with reference to FIG. 6.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. An interrupt-prohibited section measurement method, performed by a computing system, the interrupt-prohibited section measurement method comprising:
increasing an interrupt count in response to a first interrupt request signal;
recording a first time, which is a time when the first interrupt request signal is sent, based on an increase in the interrupt count;
decreasing the interrupt count in response to a second interrupt request signal different from the first interrupt request signal;
recording a second time, which is a time when the second interrupt request signal is sent, based on a decrease in the interrupt count; and
calculating a duration of an interrupt-prohibited section using the first and second times.

2. The interrupt-prohibited section measurement method of claim 1,
wherein the first interrupt request signal includes multiple request signals, and
each of the multiple request signals of the first interrupt request signal precedes the second interrupt request signal.

3. The interrupt-prohibited section measurement method of claim 2, wherein the first time is a time when an earliest of the multiple request signals of the first interrupt request signal is recorded.

4. The interrupt-prohibited section measurement method of claim 2,
wherein the second interrupt request signal includes multiple request signals, and
the second time is a time when a latest of the multiple request signals of the second interrupt request signal is recorded.

5. The interrupt-prohibited section measurement method of claim 1, wherein the recording of the first time comprises recording the first time when the first interrupt request signal is sent, based on the increase in the interrupt count, if the interrupt count becomes one.

6. The interrupt-prohibited section measurement method of claim 1, wherein the recording of the second time comprises recording the second time when the second interrupt request signal is sent, based on the decrease in the interrupt count, if the interrupt count becomes zero.

7. The interrupt-prohibited section measurement method of claim 1, wherein the calculating of the duration of the interrupt-prohibited section comprises calculating the duration of the interrupt-prohibited section by subtracting the first time from the second time.

8. The interrupt-prohibited section measurement method of claim 7, further comprising:
if the calculated duration of the interrupt-prohibited section exceeds a predetermined maximum value, updating the predetermined maximum value and recording the duration calculated by subtracting the first time from the second time in a program counter.

9. The interrupt-prohibited section measurement method of claim 7, further comprising:
if the calculated duration of the interrupt-prohibited section is equal to or less than a predetermined maximum value, increasing the interrupt count in response to another first interrupt request signal;
recording another first time, which is a time when the another first interrupt request signal is sent, based on an increase in the interrupt count in response to the another first interrupt request signal;
decreasing the interrupt count in response to another second interrupt request signal different from the another first interrupt request signal; and
recording a second time, which is a time when the another second interrupt request signal is sent, based on a decrease in the interrupt count in response to the another second interrupt request signal.

10. An interrupt-prohibited section measurement system comprising:
at least one processor; and
a memory storing instructions,
wherein by executing the stored instructions, the at least one processor is configured to perform operations of:
increasing an interrupt count in response to a first interrupt request signal;
recording a first time, which is a time when the first interrupt request signal is sent, based on an increase in the interrupt count;
decreasing the interrupt count in response to a second interrupt request signal different from the first interrupt request signal;
recording a second time, which is a time when the second interrupt request signal is sent, based on a decrease in the interrupt count; and
calculating a duration of an interrupt-prohibited section using the first and second times.

11. The interrupt-prohibited section measurement system of claim 10,
wherein the first interrupt request signal includes multiple request signals, and
each of the multiple request signals of the first interrupt request signal precedes the second interrupt request signal.

12. The interrupt-prohibited section measurement system of claim 11, wherein the first time is a time when an earliest of the multiple request signals of the first interrupt request signal is recorded.

13. The interrupt-prohibited section measurement system of claim 11,
wherein the second interrupt request signal includes multiple request signals, and
the second time is a time when a latest of the multiple request signals of the second interrupt request signal is recorded.

14. The interrupt-prohibited section measurement system of claim 10, wherein the recording of the first time comprises recording the first time when the first interrupt request signal is sent, based on the increase in the interrupt count, if the interrupt count becomes one.

15. The interrupt-prohibited section measurement system of claim 10, wherein the recording of the second time comprises recording the second time when the second interrupt request signal is sent, based on the decrease in the interrupt count, if the interrupt count becomes zero.

16. The interrupt-prohibited section measurement system of claim 10, wherein the calculating of the duration of the interrupt-prohibited section comprises calculating the duration of the interrupt-prohibited section by subtracting the first time from the second time.

17. The interrupt-prohibited section measurement system of claim 16,
wherein the at least one processor is further configured to perform an operation of:
if the calculated duration of the interrupt-prohibited section exceeds a predetermined maximum value, updating the predetermined maximum value and recording the duration calculated by subtracting the first time from the second time in a program counter.

18. The interrupt-prohibited section measurement system of claim 16,
wherein the at least one processor further performs operations of:
if the calculated duration of the interrupt-prohibited section is equal to or less than a predetermined maximum value, increasing the interrupt count in response to another first interrupt request signal;
recording another first time, which is a time when the another first interrupt request signal is sent, based on an increase in the interrupt count in response to the another first interrupt request signal;
reducing the interrupt count in response to another second interrupt request signal different from the another first interrupt request signal; and
recording a second time, which is a time when the another second interrupt request signal is sent, based on a reduction in the interrupt count in response to the another second interrupt request signal.
